(19) United States
(12) Patent Application Publication
(10) Pub. No.: US 2024/0242218 A1
(43) Pub. Date: Jul. 18, 2024

(54) SECURE ENCLAVE IDENTITY MANAGEMENT

(71) Applicant: R3 Ltd., London (GB)

(72) Inventors: Rui Pedro Silva Marques de Almeida, London (GB); Sotiria Fytraki, London (GB)

(21) Appl. No.: 18/096,429

(22) Filed: Jan. 12, 2023

(51) Int. Cl. G06Q 20/40

(52) U.S. Cl. CPC G06Q 20/40145

(57) ABSTRACT

A secure enclave executing on a client computing system captures identification data from an identification document, where the captured data represents the personal identification information associated with a user of the client computing system. The secure enclave transmits the captured data to a validation system that is configured to validate the captured data and return a signed validation result indicating validity of the captured data. A representation of the captured data and the signed validation result is stored in a secure memory associated with the secure enclave. When a transaction is performed, a querying system requests identification data associated with the user. In response to the request, the secure enclave outputs the representation of the captured data and the signed validation result to the querying system. The querying system can then authorize or deny the transaction based on the representation of the captured data and the signed validation result.

### BACKGROUND

Many types of transactions require a person to provide confidential identification information before the transaction can be authorized. For example, people who wish to gain access to controlled areas must validate that they are authorized to enter the area, and people who desire to purchase certain age-restricted items must validate that they are of a sufficient age. However, by providing the information that is needed to validate these transactions, users often risk unnecessarily exposing their private data. When an in-store purchase requires age validation, for example, a customer typically would present an identification document such as a driver's license or a passport to a cashier, who can review private information such as the customer's full date of birth and home address while determining if the customer meets the age requirements for the transaction. For other types of transactions, user identification information is difficult to obtain. For example, when a transaction is conducted online, it may be difficult to verify that the user who initiated the transaction satisfies specified identity requirements.

### BRIEF DESCRIPTION OF THE DRAWINGS

Detailed descriptions of implementations of the present invention will be described and explained through the use of the accompanying drawings.

FIG. 1 is a block diagram of an environment in which authentication of personal information occurs, according to some implementations.

FIG. 2 is a block diagram of a client computing system that includes a trusted execution environment, according to some implementations.

FIG. 3 is an interaction diagram illustrating a process for secure validation of personal identification data in order to authorize transactions, according to some implementations.

FIG. 4 is an interaction diagram illustrating another process for secure validation of personal identification information, according to some implementations.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Many types of transactions require a person to provide confidential identification information before the transaction can be authorized. To secure private identification information while enabling validation of transactions that require such identification information, the inventors have conceived of and reduced to practice secure storage and transmission of confidential user information that enables transactions to be performed without compromising security of a person's private data.

In some implementations, a secure enclave executing on a client computing system captures identification data from an identification document, where the captured data represents the personal identification information associated with a user of the client computing system. The secure enclave transmits the captured data to a validation system that is configured to validate the captured data and return a signed validation result indicating validity of the captured data. A representation of the captured data and the signed validation result is stored in a secure memory associated with the secure enclave. When a transaction is performed, a querying system requests identification data associated with the user. In response to the request, the secure enclave outputs the representation of the captured data and the signed validation result to the querying system. The querying system can then authorize or deny the transaction based on the representation of the captured data and the signed validation result.

In other implementations, the querying system and/or the client computing system request validation of the user identification data after a transaction has been initiated at the querying system.

Implementations of the secure identity management described herein advantageously protect private information of users while enable them to conduct transactions that require or benefit from identity authentication. The user can use the client computing system to provide identity data instead of carrying an identification document. Furthermore, additional types of transactions can be enabled based on the ability of the querying system to verify a user's identity. For example, the querying system can verify the identity of a person performing an online transaction in order to improve the security of the transaction.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### System Overview

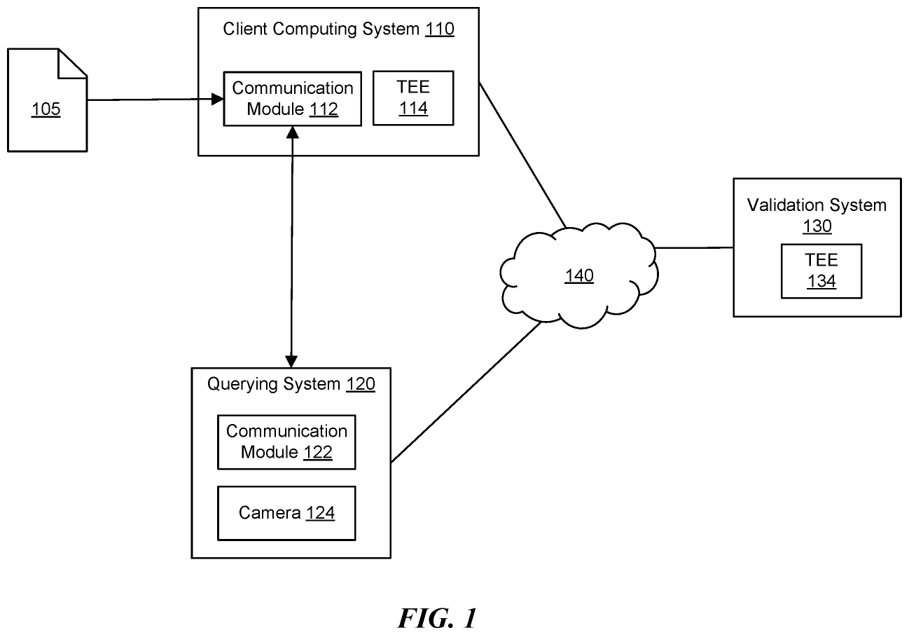

FIG. 1 is a block diagram of an example environment 100 in which authentication of personal information occurs. As shown in FIG. 1, the environment 100 can include a client computing system 110, a querying system 120, and a validation system 130. In some implementations of personal information authentication, functionality of the systems shown in FIG. 1 is divided differently among the systems.

The client computing system 110 maintains personal information associated with a user of the system 110 and outputs a secure representation of the personal information to authorize a transaction. The client computing system 110 can be, for example, a handheld mobile device (e.g., mobile phones or tablet), a laptop computer, a desktop computer, a wearable device, a smart television, a gaming console, etc. In some implementations, the client computing system 110 comprises two or more devices or computing systems. In these implementations, some of the functionality described below as being performed by the client computing system 110 may be performed by a device or system used by a user (such as the user's mobile phone), while other functions are performed by a device or system remote from the device used by the user (such as a server).

In some implementations, the client computing system 110 includes a communication module 112 to read data from an identification document 105 and/or communicate secure data to an external device, such as the querying system 120. The communication module can include circuitry for wireless communication, for example via near field communication (NFC) or ultra-wideband communication (UWB).

At least some personal identification data processed by the client computing system 110 is captured from an identification document 105 issued by a government or a governing body of an organization. Example identification documents include a passport, a driver's license, a birth certificate, or a school identification. Some personal identification data can be retrieved from an external data source such as a taxpayer record, a school enrollment record, an employment record, or a database maintaining biometric information of users that was captured by third-party identification services. Furthermore, some personal identification information can be input directly by a user of the client computing system 110. For example, a user may use a camera of the client computing system to capture a photo of the user's face or a fingerprint scan. After a representation of the identification data has been generated, at least some implementations of the client computing system 110 discard the underlying personal identification data that was used to generate the representation.

The client computing system 110 further includes a trusted execution environment (TEE) that securely processes and stores user identification data. The TEE 114 stores representations of user identification data that can be output to the querying system 120 to verify aspects of the user's identity. For some types of identification data and transactions, the TEE stores a binary value that indicates whether the user identification data satisfies a specified constraint. For example, if a user needs to verify that he or she is at least 21 years old to purchase a particular item, the TEE stores a value that indicates whether the user is older than 21, without directly storing the user's age or date of birth. For other types of identification data, the TEE generates a hash value by applying a one-way hashing function to the identification data. The hash value may represent an individual item of identification data, such as a date of birth or a country of citizenship of the user. Alternatively, the TEE can generate hash values that represent a unique fingerprint of an identification document based on multiple items of data extracted from the identification document, such as a combination of document number, user's name, user's date of birth, a photograph of the user within the document, or any other data that can be extracted from the document.

The client computing system 110 can perform a workflow to generate a “digital identity” of a user, which can be used in place of identification documents. A user inputs identification data to the client computing system 110, for example by capturing a photo of an identification document or by scanning a near-field communication chip embedded in an identification document. The client computing system 110 may then prompt the user to capture a photo of the user's face. Both the recently captured photo and the identification data are transmitted to the validation system 130 for validation. When a validation result is returned by the validation system 130, the client computing system 110 stores a digital identity that contains a representation of the identification data. The data captured from the identification document and the user's recently captured photo can be discarded for privacy.

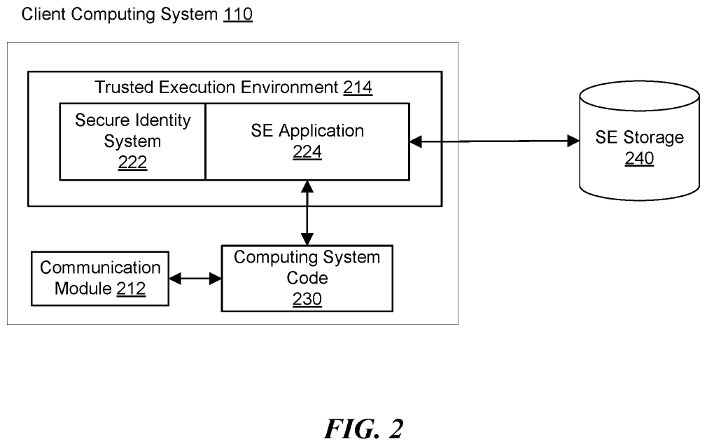

In some implementations, the TEE stores multiple representations of personal identification data, corresponding to different types of data that may be requested for various types of transactions. When a particular type of personal identification data is requested for a transaction, the TEE receives instructions that identify the requested type of information and outputs a corresponding representation of the requested information. For example, when a point-of-sale device requests validation that a user is older than 21 years old, the TEE retrieves and outputs a data object that indicates, as a binary value, whether the user is at least 21 years old. When a port of entry to a country requests validation of an identity of the user, the TEE retrieves and outputs a hashed fingerprint of the user's government-issued passport that can be validated against government records to identify the user. Components of a computing system 200 as an example implementation of the client computing system 110, are described further with respect to FIG. 2.

In some implementations, the client computing system 110 does not execute a TEE 114. The client computing system 110 can be a system trusted by its users, such as the user's mobile phone, that is capable of storing an encrypted representation of the user's identification data. For example, the user can use the mobile phone to capture data from an identification document, which the mobile phone encrypts and sends to the validation system 130 for authentication. The mobile phone then discards the raw data captured from the identification document. The encrypted identity data and/or an authentication result returned by the validation system 130 can be stored in a memory or other storage device of the mobile phone for use by the user to conduct a transaction.

A querying system 120 is the gatekeeper for a transaction, approving or denying the transaction based on authentication of the personal identification data. Any of a variety of types of transactions can be handled through the querying system 120, including payment for items or services at a point-of-sale, payment for items or services online, entry to a controlled area (e.g., in a workplace, at a sporting event, or in a transportation hub such as an airport or train station), accessing online services with age restrictions (e.g., a video streaming platform or a video game distribution platform), posting of online content (e.g., via a social media application), or voting (whether in-person or online). Some implementations of the querying system 120 can further perform transactions to validate identity of users to enforce laws, such as to reduce the incidence of illegal trade using cryptocurrencies, predatory behavior in online spaces, or violations of copyright by user content-driven platforms. The querying system 120 can also ensure compliance with privacy laws such as the General Data Protection Regulation (GDPR) or the California Consumer Privacy Act (CCPA). To enable different types of transactions, the querying system 120 can be implemented by dedicated querying system computing devices, integrated into a multi-purpose computing device (such as a point-of-sale in a store or a gating control mechanism that controls access to a restricted area), implemented in a cloud-based or distributed architecture, or executed by the client computing system 110 outside of the TEE.

The querying system 120 can receives representations of identification data from the client computing system 110 by a variety of channels, depending on the configuration of the querying system. In some cases, the identification data representations are transmitted over a wireless communication interface between the querying system 120 and client computing system 110. In other cases, the client computing system 110 generates and displays a machine-readable code that, when placed in front of a camera of the querying system 120, is readable by the querying system 120 to extract identification data. In still other cases, where the querying system 120 is implemented by the client computing system 110 outside the secure enclave, application programming interfaces can enable programmatic communications between the systems. The querying system 120 can further be configured to communication with the validation system 130, for example over the network 140.

A validation system 130 can be used to authenticate at least some types of personal information. The validation system 130 can be managed by a third party that is capable of securely validating user identification information, without exposing private user data to the querying system 120. For example, the validation system 130 can be operated by a government entity that has access to confidential user identification data such as passport data, driver's license data, birth records, or taxpayer records; by a company that has access to employment records; or by a school that has access to enrollment records. Alternatively, the validation system 130 can be operated independently of a governing entity but able to access user identification data from the governing entity. The validation system 130 can include a TEE 134 that is similar to the TEE 114. In some cases, the validation system 130 does not process underlying data values associated with user identification information, but instead validates user data maintained by a client computing system 110 by comparing a hash value of the user data maintained by a governing entity to a hash value of the data maintained by the client computing system. Thus, while in some implementations the validation system 130 is a trusted entity that has access to at least some raw personal identification data and processes such raw data in the TEE 134, other implementations do not require the validation system 130 to be a trusted entity. The validation system 130 can perform validation of user identity data in an offline manner (before any particular transaction is initiated), in an online manner (during a transaction), or both. Processing of personal identification data or representation of personal identification data can be performed within a secure enclave associated with the validation system in some implementations.

The validation system 130 generates signed validation results when user identity data is determined to be authentic. The signed validation results can include, for example, a secure certificate issued by an authority operating the validation system 130 or a data item that is signed using private keys maintained by the validation system 130. For example, when the validation system 130 is used to validate that passport data from a user is authentic, the state or country issuing the passport has a country signing certification authority (CSCA) key pair and a document signer certificate (DSC) key pair. The public keys of each of these key pairs is stored in a public key directory. When the querying system 120 receives a representation of passport data that is signed using the private keys of the issuing country, the querying system 120 consults the public key directory to validate the private key signature, determining that the passport data is authentic if the private keys are validated.

Communications between the client computing system 110, querying system 120, and validation system 130 can be enabled by a network 140, which can include any of a variety of individual connections via the internet such as cellular or other wireless networks, such as 4G networks, 5G networks, or WiFi. In some embodiments, the network may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security. The network may comprise any type of computer networking arrangement used to exchange data. For example, the network may be the Internet, a private data network, virtual private network using a public network, and/or other suitable connection(s) that enables components in system environment 100 to send and receive information between the components of system environment 100. The network may also include a public switched telephone network (“PSTN”) and/or a wireless network.

### Trusted Execution Environment

FIG. 2 is a block diagram of a computing system 200 having a trusted execution environment, according to some implementations. As shown in in FIG. 2, the computing system 200 includes a trusted execution environment (TEE) 214, a communication module 212, and client code 230. The computing system 200 is an example implementation of the client computing system 110, the validation system 130, or another computing system that includes a TEE for securely processing or storing information.

The TEE 214, also referred to as a secure enclave, refers to a feature of a central processing unit (“CPU”) in which code and data of code (i.e., trusted code) are stored in memory in encrypted form and decrypted only when retrieved for use by the CPU. Such code is said to execute in the secure enclave. During manufacture, the secure enclave is provided a set of CPU private keys. The CPU private keys are stored in such a way that they cannot be altered in any way, including being deleted. The CPU supports generating an attestation of the trusted code that executes in the secure enclave. The attestation includes a hash of the trusted code, an identifier of the CPU, and application data. The attestation is signed by a CPU private key that is known to the manufacturer. A third party can request the CPU to provide the attestation as evidence of the trusted code that executes in the secure enclave. The third party can request a service of the manufacturer of the CPU to verify the signature. The third party can then verify that the hash is a hash of the trusted code that the third party expects. The attestation may also include a public key that the third party can use to encrypt data that the secure enclave can decrypt using the corresponding private key. An example type of secure enclave that can be used by the computing system 200 is that provided by the Software Guard Extensions (“SGX”) feature of Intel Corporation.

The TEE 214 creates a tamper-proof space for the code of a secure enclave (SE) application 224 to execute, so that other portions of the computing system 200 (including the computing system code 230) cannot inspect or interfere with its execution. The TEE 214 protects data at rest (within the TEE), in motion (between the TEE and storage), and during computation (within the TEE). Before engaging with a TEE of another node, the TEE 214 can produce an attestation that it has been secured, is running the correct code of the application 224, and has not been tampered with. The code of the application 224 communicates with other nodes, such as the validation system 130, using encrypted messages, for example, encrypted transaction offers. The encryption may be based on public/private key pairs or symmetric keys of the application.

The TEE 214 can provide isolated tamper-proof enclaves for each of multiple SE applications 224 executed within the computing system 200. For example, an enclave is managed for an SE application corresponding to each of a plurality of computing system applications executed by the computing system 200, such that each of the plurality of computing system applications corresponds to a different, isolated enclave. The computing system 200 maintains a record of all enclaves that have been created, for example in an enclave page cache (EPC). The EPC represents a subset of processor reserved memory (PRM), which cannot be directly accessed by other software within the computing system 200 or by an external system. Each enclave can be allocated a pointer to its own memory area in a shared memory between the computing system application and the SE application 224 to reduce the ability of the computing system to pass information between enclaves using the shared memory.

The computing system code 230 represents untrusted code that executes outside of the TEE 214. In some cases, the computing system code 230 is configured to interface or communicate with the client computing system 110, the querying system 120, or the validation system 130, via peer-to-peer communication or a network 140. For example, a computing system application on the client system 110 that represents a subset of the computing system code 230 can include functionality to send data to or receive data from the querying system 120 and validation system 130 via the communication module 212. Other computing system applications can include functionality to perform online transactions by communicating with a remote transaction server. For example, the computing system 200 can execute applications such as a browser application (through which a user can, for example, place an order through an ecommerce website), a social media application (through which a user can post social media content items), or a freelance work application (through which a user can offer the user's freelance services for purchase by other users).

The secure identity system 222 maintains representations of identity data of a user of the computing system 200. The secure identity system 222 processes identity data that was captured from an identity document 105, retrieved from an external data source, and/or input by the user, in order to generate a secure representation of the data. For example, the secure identity system 222 applies a one-way hashing algorithm to identity data or computes a binary indicator of whether the identity data satisfies a specified requirement. The secure identity system 222 can generate multiple identity data representations that correspond to different types of identity data or different transaction requirements. The representations of user identity data can be stored in a secure enclave storage 240 that is accessible only to the secure identity system 222 or accessible to both the secure identity system 222 and the SE application 224.

In some implementations, the secure identity system 222 is part of the SE application 224 or a separate service provided to the application 224. Alternatively, some of the functions of the secure identity system can be implemented as part of the application 224 and other functions can be provided by the separate service.

### Authorizing Transactions Using Secure Identity Data

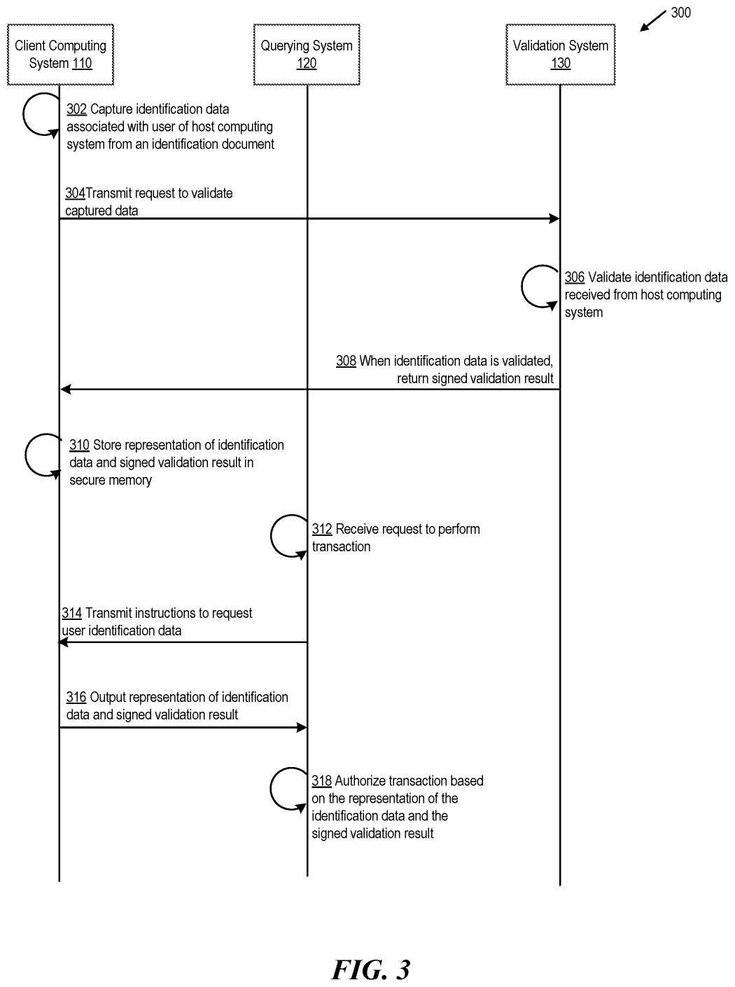

FIG. 3 is a flowchart illustrating a process 300 for secure validation of personal identification data in order to authorize transactions, according to some implementations. In the process 300, validation of user identification data is performed in advance of any transaction that may request the identification data. As shown in FIG. 3, the process 300 includes interactions between the client computing system 110, the querying system 120, and the validation system 130. Other implementations of the process 300 can include additional, fewer, or different steps, and can perform the steps in different orders.

At step 302, the client computing system 110 captures identification data associated with a user of the client computing system. The identification data can be captured from an identification document, retrieved from an external source, and/or input to the client computing system 110 directly by the user. The TEE of the client computing system 110 can be responsible for handling of the identification data.

At step 304, the client computing system 110 transmits a request to the validation system 130 to validate the captured identification data. The validation system 130 performs a validation at step 306, for example by confirming that information captured from a government-issued identification document of the user matches corresponding information maintained in government databases. In some implementations, the request transmitted from the client computing system 110 includes a recently captured photo of the user, which is compared by the validation system 130 to a preexisting photo of the user (e.g., a driver's license photo). For example, when the user requests The validation system 130 returns a signed validation result to the client computing system 110 at step 308, which indicates whether the validation system successfully validated the identification data.

At step 310, the client computing system 110 stores a representation of the identification data and the signed validation result in the secure enclave memory 240. Depending on the type of identification data and/or the types of transactions for which the identification data is requested, the representation stored by the client computing system 110 can include a hash of at least a portion of the identification data, a binary indicator of whether the identification data satisfies a specified constraint, or a data object that contains information related to the identification data and a signature or certificate from the validation system 130. After storing the representation, the client computing system 110 can discard the underlying identification data, such that only the representation is maintained in memory at the client computing system 110.

At step 312, the querying system 120 receives a request to perform a transaction for which personal identification data is needed before the querying system can authorize the transaction. The request is received in some cases based on a user input at the querying system 120. For example, when the querying system is implemented in a point-of-sale device, the point-of-sale device may include functionality that enables the user to directly input a request to perform a transaction. Similarly, when the querying system is implemented in an application executed outside the TEE of the client computing system 110, the application may receive a direct user input to initiate a transaction. In other cases, the querying system 120 receives the request via a communication received from another system. For example, the querying system receives a programmatic function call from another application executed by the client computing system 110 (inside or outside the TEE) or a communication transmitted to the querying system 120 from a remote computing device.

In response to the request, the querying system 120 transmits instructions to the client computing system 110 at step 314 to request the identification data that is needed for the transaction. In some implementations, the instructions can be transmitted via a wireless communication interface between the querying system 120 and the client computing system 110, for example when the querying system is integrated into a point-of-sale device in a store and the client computing system 110 communicates with the point-of-sale device by near field communication. In other implementations, the instructions are transmitted via a programmatic function call, for example when the querying system is integrated into an application of the client computing system 110 that is executed outside of the TEE.

In response to the request from the querying system 120, the client computing system 110 outputs the representation of the requested identification data at step 316. The output representation can include or be accompanied by the signed validation result received from the validation system 130.

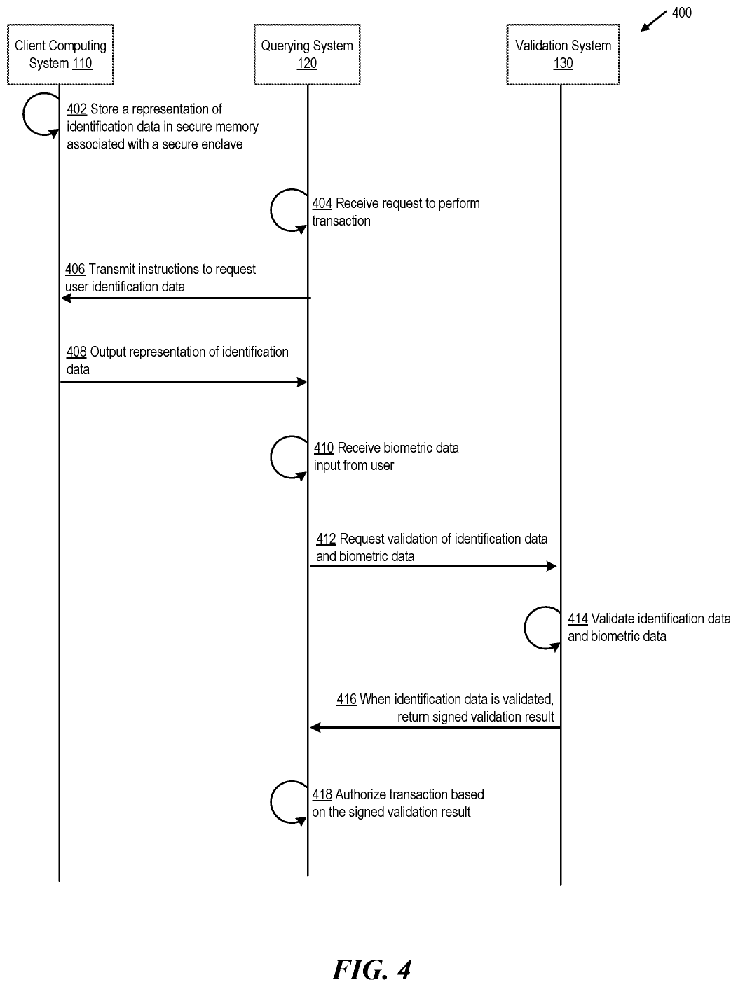

At step 318, the querying system 120 authorizes the transaction based on the representation of the identification data and the signed validation result. For some types of transactions and some configurations of the identification data representations, the querying system 120 can authorize the transaction based on the data received from the querying system 120. For example, if the identification data representation is signed by a private key of the validation system 130, the querying system 120 retrieves a corresponding public key and, if the public key authenticates the private key used to sign the representation, the querying system 120 determines the representation is authentic. In other cases, the querying system 120 requests additional validation of the identification data representation from the validation system 130, which is described with respect to FIG. 4.

FIG. 4 is a flowchart illustrating another process 400 for secure validation of personal identification information, according to some implementations. In the process 400, validation of user identification data is performed during processing of a transaction. Additionally, like the process 300, the process 400 includes interactions between the client computing system 110, the querying system 120, and the validation system 130. Other implementations of the process 400 can include additional, fewer, or different steps, and can perform the steps in different orders. Some of the steps performed during the process 400 can be similar to steps described with respect to the process 300.

At step 402, the client computing system 110 stores a representation of user identification data in a secure memory associated with a trusted execution environment. At step 404, the querying system 120 receives a request to perform a transaction. In response to the request, the querying system 120 transmits instructions to the client computing system 110 at step 406 to request the identification data that is needed for the transaction. At step 408, the client computing system 110 outputs a representation of the identification data that is requested for the transaction.

For some types of transactions, the querying system 120 optionally receives an input of biometric data from the user at step 410, in addition to requesting the identification data, in order to validate that the identification data belongs to the user who is performing the transaction. For example, the querying system 120 captures a photograph of the face of the user using a camera of the querying system 120, captures fingerprint data of the user using a fingerprint scanner, or captures a retinal scan of the user using an eye scanner. In addition to or instead of requesting biometric data, the querying system 120 can request other data inputs from the user to validate identity of the user, such as entry of a password or personal identification number, answer of a secret question, etc.

The querying system 120 sends the representation of the user identification data and, if applicable, any biometric data or other user inputs received at the querying system 120, to the validation system 130 at step 414. The validation system 130 determines whether the identification data is valid by comparing the received identification data to identification data maintained by a government or governing body of an organization. In an example, the validation system 130 compares a received hash value, which represents the user's personal identification data, to a hash value maintained in a government database. The validation system 130 also compares received biometric data to corresponding biometric data stored in the government database. If both the received hash values and biometric data match their stored counterparts, the validation system 130 determines that the user identification data received at the querying system 120 is valid.

If the identification data is validated, the validation system 130 returns a signed validation result to the querying system 120 at step 416. At step 418, the querying system 120 authorizes the transaction based on the signed validation result. For example, the querying system authorizes the transaction when the result returned by the validation system 130 indicates that the identification information matches the user who is requesting the transaction and that the user's identification information satisfies a requirement for the transaction.

In some implementations, when validating the received identification data at step 414, the validation system 130 determines whether the identification data satisfies a requirement for the transaction, such as age requirements, citizenship requirements, or requirements for membership in or employment by a particular organization. The signed validation result returned to the querying system 120 by the validation system 130 in these implementations can include a binary value that indicates whether the requirement for the transaction is satisfied, without exposing the underlying user identification data to the querying system 120.

In other implementations of the process 400, the client computing system 110 transmits the representation of the identification data directly to the validation system 130, without first sending the representation to the querying system 120. For example, after a request to perform a transaction is received at the querying system 120 at step 404, the querying system 120 sends the client computing system 110 instructions to provide user identification data to the validation system 130. The instructions from the querying system 120 can also include an identifier of the querying system 120. The client computing system 110 in turn transmits the representation of the user identification data to the validation system 130 for validation, with instructions to return the validation result to the querying system 120 based on the identifier of the querying system.

### Example Transactions

In one example use of the identity validation processes described herein, the querying system is a point-of-sale device through which a user of the client computing system is purchasing an item that requires age validation. When the querying system determines that age validation is needed, it outputs an instruction to the user to provide age information. Rather than showing an identification document to a store clerk for validation, the user initiates a wireless transfer of secure, validated age data from the TEE to the querying system, for example by tapping the client computing system against the point-of-sale near an NFC communication module. The querying system can output instructions that cause the TEE to output the secure data item representing the information that is relevant to the transaction. For example, if the transaction requires the user to be greater than 21 years old, the TEE outputs a secure data item that includes a binary indication either that the user is greater than 21 or less than 21, without providing the user's precise age.

In another example, when a user is passing through a point of entry to a country (e.g., in an airport or train station), the user taps the client computing against a querying system implemented in a gate control system. The TEE transfers hashed citizenship and/or visa data, derived from the user's passport, to the querying system. The querying system also captures a photo of the user. The photo and the hashed data are transmitted to the validation system, which authenticates identity of the user based on the photo and authenticity of the citizenship or visa data that is associated with the user. The validation system then returns a signed result to the querying system, indicating whether the user is authorized to pass through the gate or not. If the signed result indicates the user is authorized, the querying system causes the gate to open to allow the user to pass through.

In still another example, a user desires to perform an online transaction of creating a social media post. A social media application, executed by the client computing system outside the TEE, sends a query to the TEE for information to validate that the social media post is being created by a person and not an automated script. The TEE outputs a representation of the user's identity to validate the personhood of the user.

In some implementations of the identity validation process enabled by the systems described herein, validation is performed by the validation system 130, remote from both the client computing system 110 and the querying system 120, to ensure that both parties trust the result of the validation. For example, if the user of a mobile phone (as an example implementation of the client computing system 110) compromises the identity data stored on the mobile phone, the compromised data may fool the querying system 120. The use of the validation system 130 enables the querying system 120 to ensure that the information provided by the mobile phone is correct. On the other hand, if a vulnerability on the validation system 130 affects the validation output provided by the validation system, the user's data is typically protected (even if the user did not receive the expected validation result). If a user does not trust the output of the validation system 130, such as if the validation system 130 does not confirm the user's correct age, the user typically knows the information that is being validated and can challenge the querying system 120 to, for example, request a different validation system 130.

### Secure Storage of Data Streams

The TEE 114 of the client computing system 110 can additionally or alternatively be used to securely maintain data streams such that the raw data of the data streams is not directly accessible. Such raw data streams can include, for example, a stream of video data captured by a video surveillance system or a stream of sensor data associated with a system for monitoring environments such as roadway infrastructure, traffic patterns, or industrial processes.

In an example implementation, a secure enclave application within the TEE 114 captures the stream of raw data and encrypts it in a manner that can only be decrypted by a general purpose enclave. The SE application maintains the encrypted data in secure enclave storage and logs any access to the data. The TEE can also perform custom processing on the raw data, depending on the type of data that is captured or the purpose for which the data is captured. For example, in the case of a stream of video data, the TEE blurs faces or alphanumeric data (e.g., from vehicle license plates) before storing the data or providing it to an external system.

In some implementations, the TEE enables justified access to the underlying raw data in a manner similar to that described above for identity data. When, for example, a law enforcement agency has a search warrant for a particular vehicle, an operator can request video data based on a photo, a vehicle license plate, or characteristics of the vehicle. The TEE analyzes the video stream based on the request. If matching portions of the video are found, the TEE outputs segments of the video data that are likely to contain the vehicle of interest without exposing the full raw video stream.

### Computer System

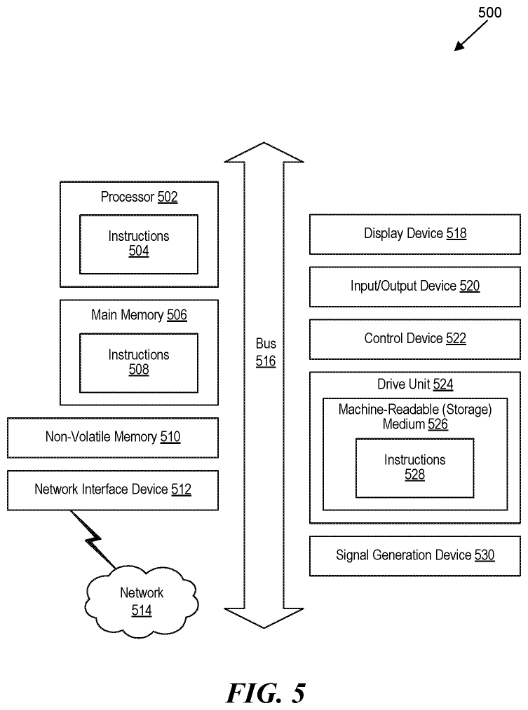

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, video display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application

1. A method performed by an application of a secure enclave executing on a client computing system to support secure validation of personal identification information, the method comprising:
capturing identification data from one or more identification documents, the captured identification data representing personal identification information associated with a user of the client computing system;
transmitting the captured identification data to a validation system, wherein the validation system is configured to validate at least a portion of the captured identification data and return a signed validation result indicating validity of the captured identification data;
storing a representation of the captured identification data and the signed validation result in a secure memory associated with the secure enclave; and
outputting the representation of the captured identification data and the signed validation result to a querying system in response to an instruction received from the querying system,
wherein the querying system is configured to authorize a transaction based on the representation of the captured identification data and the signed validation result.

2. The method of claim 1, further comprising, in response to the instruction received from the querying system:
capturing biometric data from the user of the client computing system; and
outputting the biometric data in association with the representation of the captured identification data to the querying system,
wherein the querying system is configured to validate that the representation of the captured identification data is personal identification information of the user of the client computing system based on the biometric data.

3. The method of claim 1, further comprising:
retrieving additional identification data from an external data source; and
storing a representation of the additional identification data.

4. The method of claim 1, wherein storing the representation of the captured identification data comprises storing multiple representations that each correspond to different types of personal identification information of the user of the client computing system, and wherein the method further comprises:
parsing the instruction received from the querying system to determine a type of personal identification information that is requested; and
selecting the representation of the requested type of personal identification information for output to the querying system.

5. The method of claim 1, wherein storing the representation of the captured identification data comprises computing a binary value indicating whether the captured identification data satisfies a requirement for the transaction.

6. The method of claim 1, wherein storing the representation of the captured identification data comprises:
computing a hash value of the captured identification data using a one-way hashing function; and
storing the hash value.

7. The method of claim 1, wherein the signed validation result comprises a data object signed by one or more private keys of the validation server.

8. The method of claim 1, wherein outputting the representation of the captured identification data and the signed validation result to the querying system comprises:
generating a communication for transmission via a wireless communication interface of the client computing system.

9. The method of claim 1, wherein outputting the representation of the captured data and the signed validation result to the querying system comprises:
generating a response to an application function call received from an application executed by the client computing system outside the secure enclave.

10. The method of claim 1, further comprising:
after storing the representation of the captured data and the signed validation result, discarding the captured identification data at the client computing system.

11. One or more computing systems with a trusted execution environment (TEE), the one or more computing systems comprising:
at least one hardware processor; and
at least one non-transitory memory associated with the TEE and storing instructions, which, when executed by the at least one hardware processor, cause the one or more computing systems to:
store, in the at least one non-transitory memory, a representation of identification data associated with a user;
receive a request from a querying system for the identification data associated with the user; and
in response to the request:
capture biometric data associated with the user; and
transmit the representation of the identification data and the biometric data to the querying system;
wherein the querying system is configured to authenticate the representation of the identification data by transmitting at least the biometric data to a validation system to validate the biometric data, and to authorize a transaction based on the representation of the identification data and a validation result generated by the validation system.

12. The one or more computing systems of claim 11, further comprising:
a wireless communication interface;
wherein the instructions further cause the one or more computing systems to capture the identification data associated with the user from an identification document via the wireless communication interface.

13. The one or more computing systems of claim 12, wherein the instructions further cause the one or more computing systems to transmit the representation of the identification data and the biometric data to the querying system via the wireless communication interface.

14. The one or more computing systems of claim 11, wherein transmitting the representation of the identification data and the biometric data to the querying system comprises generating a response to an application function call received from an application executed by the one or more computing systems outside the TEE.

15. The one or more computing systems of claim 11, wherein storing the representation of the identification data comprises computing a binary value indicating whether the captured data satisfies a requirement for the transaction.

16. The one or more computing systems of claim 11, wherein storing the representation of the captured data comprises:
computing a hash value of the captured data using a one-way hashing function; and
storing the hash value.

17. A computer-readable storage medium, excluding transitory signals and carrying instructions, which, when executed by at least one data processor of a system, cause the system to:
store, in a memory associated with a secure enclave, a representation of identification data associated with a user;
receive a request from a querying system for the identification data associated with the user;
in response to the request:
transmit the representation of the identification data to the querying system, and
transmit the representation of the identification data to a validation server, wherein the validation server is configured to authenticate the identification data based on the representation of the identification data and return a signed validation result to the querying system,
wherein the querying system is configured to configured to authorize a transaction based on the representation of the identification data and the signed validation result.

18. The computer-readable storage medium of claim 17, wherein the instructions further cause the system to transmit the representation of the identification data to the querying system via a wireless communication interface.

19. The computer-readable storage medium of claim 17, wherein transmitting the representation of the identification data to the querying system comprises generating a response to an application function call received from an application executed by the one or more computing systems outside the secure enclave.

20. The computer-readable storage medium of claim 17, wherein storing the representation of the identification data comprises storing multiple representations that each correspond to different types of personal identification information of the user, and wherein the instructions further cause the system to:
parse the request received from the querying system to determine a type of personal identification information that is requested; and
select the representation of the requested type of personal identification information for output to the querying system.
